(19) United States
(12) Patent Application Publication
(10) Pub. No.: US 2016/0306221 A1
(43) Pub. Date: Oct. 20, 2016

(54) LIQUID CRYSTAL DISPLAY PANEL, MANUFACTURING METHOD THEREOF AND DISPLAY DEVICE

(71) Applicant: BOE TECHNOLOGY GROUP CO., LTD., Beijing (CN)

(72) Inventor: Zhicheng WANG, Beijing (CN)

(73) Assignee: BOE TECHNOLOGY GROUP CO., LTD., Beijing (CN)

(21) Appl. No.: 15/071,830

(22) Filed: Mar. 16, 2016

(30) Foreign Application Priority Data
Apr. 20, 2015 (CN) 201510187808.X

(51) Int. Cl. G02F 1/1333

(52) U.S. Cl. CPC G02F 1/133351

(57) ABSTRACT

A liquid crystal display panel, a manufacturing method thereof and a display device are provided. The manufacturing method of the liquid crystal display panel includes: applying sealant on a first motherboard or a second motherboard; forming an absorbing layer for absorbing laser emitted by a laser device in a region of the first motherboard corresponding to cutting lines or a region of the second motherboard corresponding to the cutting lines; cell-assembling the first motherboard with the second motherboard; wherein, the absorbing layer is in close contact with the first motherboard and the second motherboard, respectively; and cutting on a side of the first motherboard or a side of the second motherboard by using the laser device, to form a plurality of liquid crystal display panels.

### TECHNICAL FIELD

Embodiments of the present disclosure relate to a liquid crystal display panel, a manufacturing method thereof and a display device.

### BACKGROUND

A cutting process is an important process in a process of fabricating a liquid crystal display panel. After two motherboards are cell-assembled, the cell-assembled motherboard should be cut, to form a plurality of liquid crystal display panels.

At present, the two motherboards are usually cut by a cutting wheel, respectively; the cutting wheel is in contact with the motherboards, which may cause foreign matter pollution, and furthermore, it is apt to generate burrs at a cutting position by using a cutting process of the cutting wheel, resulting in a poor cutting effect. With development of a laser industry, a laser cutting process emerges at the right moment. The laser cutting process is a process of non-contact type, which can avoid the foreign matter pollution; and furthermore, burrs may be reduced by establishing a high temperature gradient field, resulting in an excellent cutting effect. However, the laser cutting process is to heat a partial region of a glass substrate by laser, a high temperature gradient field is formed in a heating region and a unheated region due to poor thermal conductivity of the glass, resulting in change of thermal stress, such that the glass substrate is broken along a direction of the high temperature gradient field.

In addition, the two motherboards are cut respectively in an existing laser cutting process; after a motherboard on one side is cut, the cell-assembled motherboard should be turned over, so as to cut a motherboard on another side again, and furthermore, in a process of a second cutting, it is necessary to align with a cutting line of the first cutting, actual operation process is relatively complex, and there is a large error in the process of cutting.

### SUMMARY

An embodiment of the invention provides a manufacturing method of a liquid crystal display panel, comprising: applying sealant on a first motherboard or a second motherboard; forming an absorbing layer for absorbing laser emitted by a laser device in a region of the first motherboard corresponding to cutting lines or a region of the second motherboard corresponding to the cutting lines; cell-assembling the first motherboard with the second motherboard; wherein, the absorbing layer is in close contact with the first motherboard and the second motherboard, respectively; and cutting on a side of the first motherboard or a side of the second motherboard by using the laser device, to form a plurality of liquid crystal display panels.

Another embodiment of the invention provides a liquid crystal display panel, fabricated by the manufacturing method as mentioned above.

Another embodiment of the invention provides a display device, comprising: the liquid crystal display panel as mentioned above.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a flow chart of a manufacturing method of a liquid crystal display panel provided by an embodiment of the disclosure;

FIG. 2a to FIG. 2c are structural schematic diagrams after respective steps are executed in the manufacturing method of the liquid crystal display panel provided by the embodiment of the present disclosure;

FIG. 2d is a cross-sectional diagram of FIG. 2c along a direction AA.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

Shapes and thicknesses in the accompanying drawings do not reflect true proportions of an array substrate or an counter substrate, but only aim to illustrate content of the present disclosure.

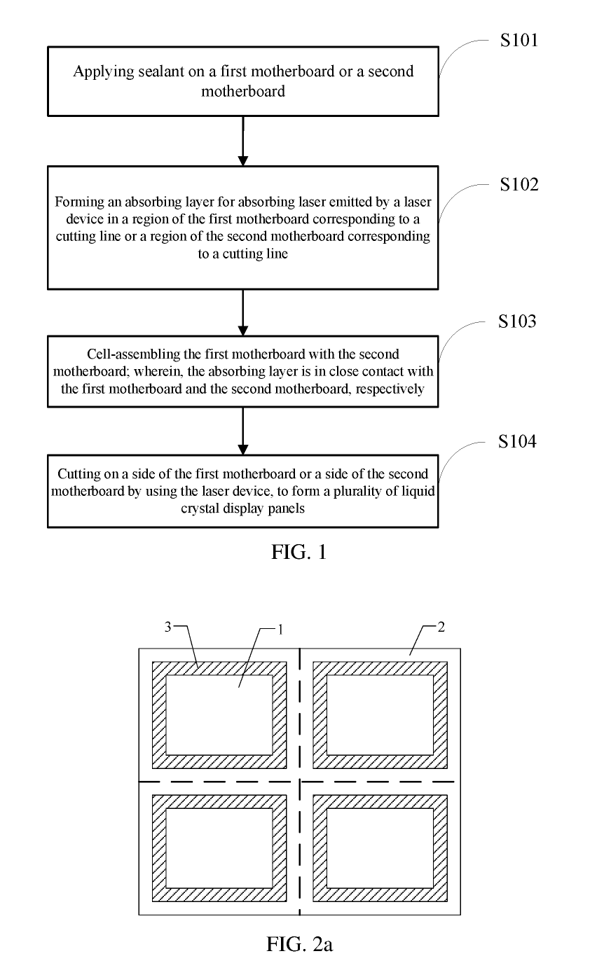

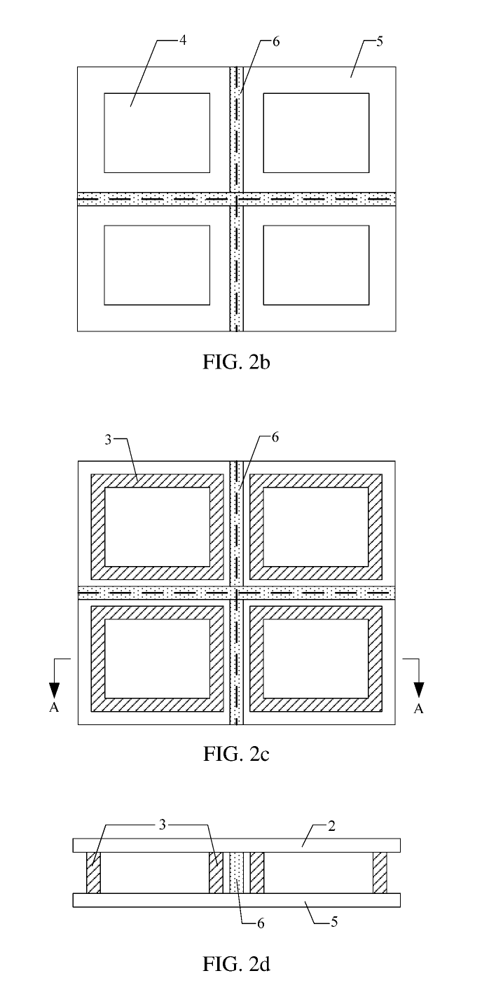

A manufacturing method of a liquid crystal display panel provided by an embodiment of the present disclosure, as illustrated in FIG. 1 and FIG. 2a to FIG. 2d, including the following steps S101-S104.

S101: applying a sealant on a first motherboard or a second motherboard; for example, the first motherboard is a motherboard of counter substrates (a motherboard of color filter substrates) where a plurality of patterns of the counter substrates have been formed, and the second motherboard is a motherboard of array substrates where a plurality of patterns of the array substrates have been formed.

As illustrated in FIG. 2a, it is described by taking an example of applying sealant 3 on a first motherboard 2 where a plurality of patterns of counter substrates 1 have been formed; for example, a plurality of regions enclosed by the sealant correspond to a plurality of unit panel regions.

S102: forming an absorbing layer for absorbing laser emitted by a laser device in a region of the first motherboard corresponding to cutting lines or a region of the second motherboard corresponding to the cutting lines.

As illustrated in FIG. 2b, it is described by taking an example of forming an absorbing layer 6 in a region corresponding to cutting lines (as illustrated by dotted lines in FIG. 2b) on a second motherboard 5 where a plurality of patterns of array substrates 4 have been formed; for example, the cutting line is formed between the plurality of unit panel regions.

S103: cell-assembling the first motherboard with the second motherboard; wherein, the absorbing layer is in close contact with the first motherboard and the second motherboard, respectively.

As illustrated in FIG. 2c and FIG. 2d, FIG. 2d is a cross-sectional diagram of FIG. 2c along a direction AA, the first motherboard 2 and the second motherboard 5 are cell-assembled, and the absorbing layer 6 is in close contact with the first motherboard 2 and the second motherboard 5, respectively.

S104: cutting on a side of the first motherboard or a side of the second motherboard by using the laser device, to form a plurality of liquid crystal display panels.

In the manufacturing method of the liquid crystal display panel provided by the embodiment of the present disclosure, before cell-assembling the first motherboard where a plurality of patterns of the counter substrates have been formed and the second motherboard where a plurality of patterns of the array substrates have been formed, an absorbing layer for absorbing laser emitted by a laser device is formed in a region of the first motherboard corresponding to cutting lines or a region of the second motherboard corresponding to cutting lines, and in this way, after the cell-assembling process, the absorbing laser is located between the first motherboard and the second motherboard, and is in close contact with the first motherboard and the second motherboard, respectively, and thus, in a follow-up process of cutting the cell-assembled first motherboard and second motherboard by using the laser device, the absorbing laser may absorb energy of the laser to serve as a thermal resource, so that the first motherboard and the second motherboard establish temperature gradient fields having directions perpendicular to the first motherboard and the second motherboard at the same time, the cell-assembled first motherboard and second motherboard may be cut by a one-time cutting process, no turning-over or alignment is needed, and the cutting process is simplified. Moreover, the absorbing laser absorbs energy of the laser emitted by the laser device, which may further improve a utilization ratio of the laser device and reduce power consumption of the laser device.

It should be noted that, the sequence in executing step S101 of applying a sealant and step S102 of forming an absorbing layer in the method provided by the embodiment of the present disclosure is not limited, the sealant may be coated at first, and then the absorbing layer is formed; or, the absorbing layer may be formed at first, and then the sealant is coated, which is not limited here.

In some examples, in order to ensure relatively high absorption ratio of the absorbing layer on the laser, in step S102 of the method provided by the embodiment of the present disclosure, when forming an absorbing layer for absorbing laser emitted by a laser device, the absorbing layer may be formed by a material having a higher carbon content, for example, the absorbing layer is formed by using an adhessive doped with carbon powder or an adhessive doped with iron powder.

Of course, materials of the absorbing layer are not limited to an adhessive doped with carbon powder or an adhessive doped with iron powder, and may be other materials having a higher carbon content, or may be other materials having a higher absorption ratio on the laser, which is not limited here.

In some example, in executing step S104 of the method provided by the embodiment of the present disclosure, when cutting on a side of the first motherboard or a side of the second motherboard by using the laser device, laser may be emitted by the laser device, so that a focal point of the laser is located in the absorbing layer, which is because the laser emitted by the laser device has highest energy in the focal point; when the focal point of the laser is located in the absorbing layer, the absorbing layer has highest utilization ratio on the laser emitted by the laser device. For example, the focal point of the laser emitted by the laser device may be located in the absorbing layer by using auto-focusing software.

Further, in the method provided by the embodiment of the present disclosure, when emitting laser by the laser device, so that a focal point of the laser is located in the absorbing layer, a distance from the focal point of the laser to the first motherboard may be equal to a distance from the focal point of the laser to the second motherboard, that is, the focal point of the laser emitted by the laser device is located in a central position of the absorbing layer perpendicular to directions of the first motherboard and the second motherboard, and in this way, after the absorbing layer absorbs energy of the laser emitted by the laser device, symmetrical temperature gradient fields may be established on the first motherboard and the second motherboard at the same time, so as to ensure that cutting speeds and cutting effects of the first motherboard and the second motherboard are same, and further ensure cutting quality of the laser cutting process.

In some examples, in step S104 of the method provided by the embodiment of the present disclosure, cutting on a side of the first motherboard or a side of the second motherboard by using the laser device, may be implemented in a manner of: fixing the cell-assembled first motherboard and second motherboard, cutting by using a supporting piece to drive the laser device to move along a cutting line on a side of the first motherboard or a side of the second motherboard. Since the absorbing layer is located in a region corresponding to cutting lines between the first motherboard and the second motherboard, when using a supporting piece to drive the laser device to move along a cutting line on a side of the first motherboard or a side of the second motherboard, the absorbing laser may absorb energy of laser emitted by the laser device to serve as a thermal resource, so that the first motherboard and the second motherboard establish temperature gradient fields having directions perpendicular to the first motherboard and the second motherboard at the same time, and the cell-assembled first motherboard and second motherboard may be cut by a one-time cutting process. Furthermore, cutting is implemented by using the supporting piece to drive the laser device to move along the cutting line, and therefore, the method provided by the embodiment of the present disclosure is especially applicable to fabricating an irregular panel, i.e., a panel of irregular shape. In a process of cutting, a moving speed of the laser device driven by the supporting piece may be adjusted according to actual situation.

In the method provided by the embodiment of the present disclosure, in a process of cutting by using the laser device, it is not limited to fixing the cell-assembled first motherboard and second motherboard, and cutting by using a supporting piece to drive the laser device to move along a cutting line; or, the laser device may be fixed, and cutting is implemented by using a supporting piece to drive the cell-assembled first motherboard and second motherboard to move; or, the laser device, and the cell-assembled first motherboard and second motherboard may be moved together, which is not limited here.

In the method provided by the embodiment of the present disclosure, when using a supporting piece to drive the laser device to move along a cutting line on a side of the first motherboard or a side of the second motherboard, a 5-axis linkage machine tool may be used to drive the laser device to move along a cutting line on a side of the first motherboard or a side of the second motherboard; or other similar devices which can drive the laser device to move may be used, which is not limited here.

In some examples, in step S104 of the method provided by the embodiment of the present disclosure, when cutting on a side of the first motherboard or a side of the second motherboard by using the laser device, any one of a carbon dioxide laser device, a yttrium aluminium garnet (YAG) laser device and a semiconductor laser device may be used for cutting, wherein, the YAG laser device and the semiconductor laser device may support an optical fiber transmission.

In some examples, in step S104 of the method provided by the embodiment of the present disclosure, when cutting on a side of the first motherboard or a side of the second motherboard by using the laser device, the first motherboard and the second motherboard may further be cooled, for example, the first motherboard and the second motherboard may be cooled by cold air, and in this way, the first motherboard and the second motherboard may better establish temperature gradient fields perpendicular to the first motherboard and the second motherboard, and thus a cutting effect is optimized Specifically, in a process of cutting, inlet amount of the cold air may be adjusted according to actual situation.

An embodiment of the present disclosure further provides a liquid crystal display panel, which is fabricated by the method provided by the embodiment of the present disclosure, and the embodiment of the manufacturing method of the liquid crystal display panel described above may be referred to for the embodiment of the liquid crystal display panel, and repeated sessions will not be illustrated here.

An embodiment of the present disclosure further provides a display device, comprising: the above-described liquid crystal display panel provided by the embodiment of the present disclosure, and the display device may be: a mobile phone, a tablet personal computer, a television, a monitor, a laptop computer, a digital photo frame, a navigator, or any other product or part having a display function. For implementation of the display device, the embodiment of the above-described liquid crystal display panel can be referred to, and repeated sessions will not be illustrated here.

The embodiments of the present disclosure provide a liquid crystal display panel, a manufacturing method thereof and a display device. In the manufacturing method, before cell-assembling the first motherboard where a plurality of patterns of the counter substrates have been formed and the second motherboard where a plurality of patterns of the array substrates have been formed, an absorbing layer for absorbing laser emitted by a laser device is formed in a region of the first motherboard corresponding to cutting lines or a region of the second motherboard corresponding to the cutting lines, and in this way, in a follow-up process of cutting the cell-assembled first motherboard and second motherboard by using the laser device, the first motherboard and the second motherboard may establish temperature gradient fields at the same time, the cell-assembled first motherboard and second motherboard may be cut by a one-time cutting process, no turning-over or alignment is needed, so that the cutting process is simplified; and moreover, the absorbing laser absorbs energy of the laser emitted by the laser device, which may further improve a utilization ratio of the laser device and reduce power consumption of the laser device.

The foregoing embodiments merely are exemplary embodiments of the present disclosure, and not intended to define the scope of the present disclosure, and the scope of the present disclosure is determined by the appended claims.

The application claims priority of Chinese Patent Application No. 201510187808.X filed on Apr. 20, 2015, the disclosure of which is incorporated herein by reference in its entirety as part of the present application.

1. A manufacturing method of a liquid crystal display panel, comprising:
applying sealant on a first motherboard or a second motherboard;
forming an absorbing layer for absorbing laser emitted by a laser device in a region of the first motherboard corresponding to cutting lines or a region of the second motherboard corresponding to the cutting lines;
cell-assembling the first motherboard with the second motherboard; wherein, the absorbing layer is in close contact with the first motherboard and the second motherboard, respectively; and
cutting on a side of the first motherboard or a side of the second motherboard by using the laser device, to form a plurality of liquid crystal display panels.

2. The method according to claim 1, wherein, the first motherboard is a motherboard of counter substrates where a plurality of patterns of the counter substrates have been formed, and the second motherboard is a motherboard of array substrates where a plurality of patterns of the array substrates have been formed.

3. The method according to claim 1, wherein, a plurality of unit panel regions are enclosed by the sealant, and the cutting lines are located between the plurality of unit panel regions.

4. The method according to claim 1, wherein, forming the absorbing layer for absorbing laser emitted by the laser device includes:
forming an absorbing layer by using an adhessive doped with carbon powder or an adhessive doped with iron powder.

5. The method according to claim 1, wherein, cutting on the side of the first motherboard or the side of the second motherboard by using the laser device includes:
emitting laser by using the laser device, so that a focal point of the laser is located in the absorbing layer.

6. The method according to claim 5, wherein, emitting laser by using the laser device, so that the focal point of the laser is located in the absorbing layer includes:
emitting laser by using the laser device, so that a distance from a focal point of the laser to the first motherboard is equal to a distance from the focal point of the laser to the second motherboard.

7. The method according to claim 1, wherein, cutting on the side of the first motherboard or the side of the second motherboard by using the laser device includes:
fixing the cell-assembled first motherboard and second motherboard, cutting by using a supporting piece to drive the laser device to move along a cutting line on the side of the first motherboard or the side of the second motherboard.

8. The method according to claim 7, wherein, using the supporting piece to drive the laser device to move along the cutting line on the side of the first motherboard or a side of the second motherboard includes:
using a 5-axis linkage machine tool to drive the laser device to move along the cutting line on the side of the first motherboard or the side of the second motherboard.

9. The method according to claim 1, wherein, cutting on the side of the first motherboard or the side of the second motherboard by using the laser device includes:
cutting by using any one of a carbon dioxide laser device, a yttrium aluminium garnet laser device and a semiconductor laser device.

10. The method according to claim 1, cutting on the side of the first motherboard or the side of the second motherboard by using the laser device, further includes:
cooling the first motherboard and the second motherboard.

11. A liquid crystal display panel, fabricated by the manufacturing method according to claim 1.

12. A display device, comprising: the liquid crystal display panel according to claim 11.
